(19) United States
(12) Patent Application Publication
(10) Pub. No.: US 2023/0142351 A1
(43) Pub. Date: May 11, 2023

(54) METHODS AND SYSTEMS FOR SEARCHING AND RETRIEVING INFORMATION

(71) Applicant: Telefonaktiebolaget LM Ericsson (publ), Stockholm (SE)

(72) Inventors: Saravanan M, Chennai (IN); Perepu SATHEESH KUMAR, Chennai (IN)

(73) Assignee: Telefonaktiebolaget LM Ericsson (publ), Stockholm (SE)

(21) Appl. No.: 17/914,548

(22) PCT Filed: Mar. 28, 2020
(86) PCT No.: PCT/IN2020/050299

§ 371 Date: Sep. 26, 2022

(51) Int. Cl. G06N 5/022; G06F 16/35

(52) U.S. Cl. CPC G06N 5/022; G06F 16/35

(57) ABSTRACT

Methods and systems for searching and retrieving information. In one aspect, there is a method of retrieving information using a knowledge base. The method comprises receiving a search query entered by a user and using a first model to identify a category corresponding to the received search query. The method further comprises based on the received search query, a loss function of the first model, and an objective function of a second model, identifying T topics corresponding to the received search query, and performing a search for the received search query only on a part of the knowledge base that is associated with the identified category and/or the identified topics. The method further comprises retrieving one or more files associated with the identified category and/or the identified topics.

### TECHNICAL FIELD

Disclosed are embodiments related to methods and systems for searching and retrieving information.

### BACKGROUND

Efficiently handling service engineers' (domain specialists) time is a great challenge in managed services. Most service industries are trying to reduce human workforce and to replace human workforce with intelligent robots. This trend would result in a reduced number of available service engineers. Also, there may be a situation where service engineers are located far from where tasks need to be performed. In such situation, service engineers' time is wasted while the service engineers are travelling to the location where tasks need to be performed.

Also because field service operators (FSOs) usually need to search and retrieve files that are needed to perform given tasks (e.g., by using a search engine), it is desirable to promptly provide the most relevant files to the FSOs to perform the given tasks (e.g., repairs and installation), in order to reduce time that is required to perform the given tasks. Providing to FSOs information that is irrelevant to the given tasks could frustrate the FSOs and increase time required to perform the given tasks. This delay could also prevent the FOS s from performing other tasks required at different locations. Accordingly, there is a need to improve the method for searching and retrieving information.

### SUMMARY

Generally, performing a search using a search engine involves retrieving information and displaying a search result identifying the retrieved information. To retrieve relevant information, a knowledge base may be used. But as the search space increases with the amount of available information, computational complexity for performing a search using a knowledge base becomes higher. In related arts, to reduce such computational complexity, a particular searching method called an elastic search is used. Performing a search using the elastic search scheme, however, becomes insufficient to reduce the computational complexity as the amount of information that needs to be searched further increases.

Accordingly, in some embodiments, a combination of information categorization and topic modelling is used to perform a search across a knowledge base such that computational complexity of performing the search is reduced.

For example, after a set of files (e.g., a set of service manuals and/or installation instructions) are obtained, the each file is categorized based on its content using a categorization model (e.g., a machine learning categorization model). After the obtained files are categorized, words and context of the files (i.e., topics) are obtained using topic models (e.g., Natural Language Processing (NLP) models). Both of the categorization model and the topic model are interrelated mutually to execute operations to accelerate the searching process. Thus, the embodiments of this disclosure provide a fast way of retrieving files that are needed for the FSOs to perform a given tasks on a real-time basis so that the FSO can handle the given tasks effectively.

As explained above, some embodiments of this disclosure enable FSOs to perform given tasks efficiently by allowing the FSOs to obtain information that is needed or helpful for performing the given tasks in an efficient manner. Currently, most of search tools used for searching information uses elastic search as the backend. Elastic search is based on keyword matching. Using a knowledge base, however, can be helpful to streamline the searching process. The knowledge base adds more semantical information to files by constructing topology-based graph. Employing knowledge-graph based search, however, involves enormous manual work.

For example, a user has to extract keywords and/or key phrases from files, and to perform Part-of-Speech (POS) tagging and Named Entity Recognition (NER) on the extracted keywords and/or key phrases. Then, the user needs to arrange them into a knowledge base structure. The size of the obtained knowledge base depends on the size of the files. As an example, web-based search engines use a large amount of files to search across. If, however, knowledge base(s) are created for all of the files, such creation would take a large amount of memory and the number of the files to search across for a desired output might be too large, and thus it might take a long time to complete the search. Accordingly, in some embodiments of this disclosure, a technique for limiting time required to perform a search using a knowledge base is provided.

According to some embodiments, there is provided a method of retrieving information using a knowledge base. The method comprises receiving a search query entered by a user and based on the received search query, using a first model to identify a category corresponding to the received search query. One or more files may be assigned to the identified category and the first model may be a categorization model that functions to map an input to one of M different categories, where M is greater than 1. The method also comprises based on (i) the received search query, (ii) a loss function of the first model, and (iii) an objective function of a second model, identifying T topics corresponding to the received search query, where T is greater than or equal to 1. The method further comprises using the identified category and the identified topics, performing a search for the received search query only on a part of the knowledge base that is associated with the identified category and/or the identified topics. The method further comprises based on the performed search, retrieving one or more files associated with the identified category and/or the identified topics.

According to some embodiments, there is provided a method for constructing a knowledge base. The method comprises obtaining a set of N files, wherein each file included in the set of files is assigned to one of M different categories, where N and M are greater than 1. The method further comprises based on (i) content of the N files, (ii) a loss function of a first model, and (iii) an objective function of a second model, identifying a set of T topics, where T is greater than 1 and each topic is a group of one or more keywords. The method also comprises generating the knowledge base using the identified topics and for each one of the N files, based on a particular category to which the file is assigned and keywords included in the file, adding the file to the knowledge base. The first model is a categorization model that functions to map an input sentence to one of the M categories.

In another aspect there is provided an apparatus adapted to perform any of the methods disclosed herein. In some embodiments, the apparatus includes processing circuitry; and a memory storing instructions that, when executed by the processing circuitry, cause the apparatus to perform any of the methods disclosed herein.

### BRIEF DESCRIPTION OF THE DRAWINGS

The accompanying drawings, which are incorporated herein and form part of the specification, illustrate various embodiments.

FIG. 1 shows an exemplary knowledge base.

FIG. 2 shows an exemplary knowledge base according to some embodiments.

FIG. 3 is a process according to some embodiments.

FIG. 4 shows an exemplary knowledge base according to some embodiments.

FIG. 6 is a partial process according to some embodiments.

FIG. 7 is a process according to some embodiments.

FIG. 8 is a process according to some embodiments.

FIG. 9 shows an apparatus according to some embodiments.

### DETAILED DESCRIPTION

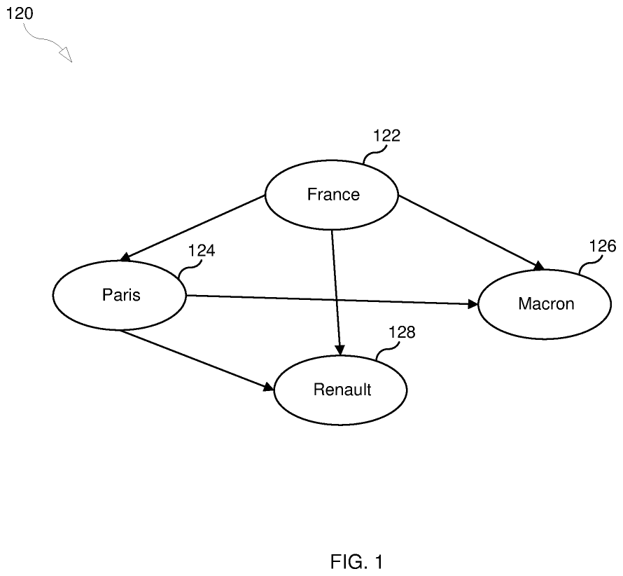

FIG. 1 illustrates a part of an exemplary knowledge base 120, which is in the form of a knowledge graph.

The knowledge graph 120 includes a top node 122 in the first layer of the knowledge graph 120 and middle nodes 124, 126, and 128 in the second layer of the knowledge graph 120. To perform a search on the knowledge graph 120, the search must be performed on the entire knowledge graph 120. The search of the entire knowledge graph 120, however, requires longer time period.

Accordingly, in some embodiments, both of a categorization and topic modelling are used such that a search only needs to be performed on a part of the knowledge graph rather than the entire knowledge graph.

For categorization, domain knowledge (e.g., hierarchy structure) or Artificial Intelligence (AI) based model may be used. As an example, convolutional neural networks (CNN) model may be used to categorize files based on an inputted search query. As used herein a “file” is a collection of data that is treated as an unit.

For topic modelling, Latent Dirichlet Allocation (LDA) model may be used to identify dominant topics in files.

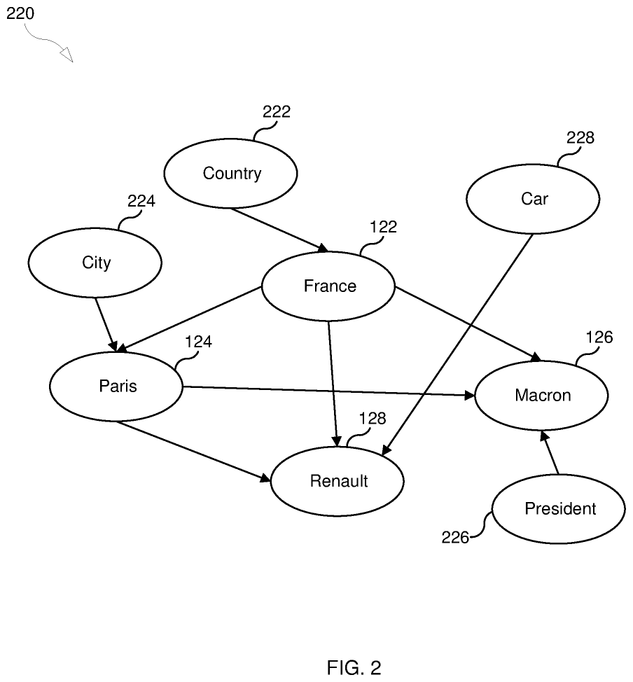

FIG. 2 illustrates a part of an exemplary knowledge graph 220 according to some embodiments. Compared to the knowledge graph 120, it is easier to perform a search on the knowledge graph 220 because for each keyword (or topic), a category (or a context) is given. Thus, if a context of user's search query can be identified, a search needs to be performed only on a part of a knowledge graph rather than the entire part of the knowledge graph. This makes a search faster and more efficient results can be obtained. This is different from a named entity recognition (NER) model as the NER model can only identify existing sentences available, for example, in Wikipedia, and domain-based words need new model. Also, from the search query, it is difficult to identify NER of the search query because it will be very small. Thus, in some embodiments, a categorization model constructed from files is used to perform a categorization of the search query.

When an LDA model is used to identify topics in files, the loss function of the LDA model is used for finding a distribution of words associated with each of the topics such that word distributions are uniform. The problem of using the loss function of the LDA model is that it is unsupervised and thus may generate poor results. Also because the text is noisy, employing a categorizer (i.e., a classifier) may result in poor results. Thus, in some embodiments, the loss function (i.e., the objective function) of the LDA model is modified by adding the loss function of the categorizer (i.e., the classifier) to the loss function of the LDA model.

Exemplary loss function of the LDA model is L=Σ_{d}^{N}Σ_{n∈N}_{_{d}} log(θ_{z}_{_{d,n}}ϕ_{z}_{_{d,n}}_{,w}_{_{d,n}}) where d corresponds to a file, N is the total number of available files, n∈N_{d} represents words included in each file, θ_{z}_{_{d,n}} is a probabilistic distribution of a document-topic distribution, and ϕ_{z}_{_{d,n}}_{, w}_{_{d,n}} is the stochastic parameter which influences distribution of words in each topic. The LDA model is used for finding words in each topic such that distribution is uniform across all topics. This process, however, is unsupervised and requires the information of the number of topics to input to the document.

Thus, according to some embodiments, the loss function of the LDA model is modified such that the modified loss function of the LDA model is based on the loss function of the categorizer as well as the loss function of the LDA model. For example, the modified loss function of the LDA model is L_{mod}=L_{unmod}+∥y_{d}−ŷ_{d}∥₂², where L_{unmod}=Σ_{d}^{N}Σ_{n∈N}_{_{d}} log(θ_{z}_{_{d,n}}ϕ_{z}_{_{d,n}}_{,w}_{_{d,n}}), y_{d} is actual category of a file (i.e., predefined category of the file) that is to be inputted to the categorizer, and ŷ_{d} is predicted category determined by the categorizer. By factoring in two-norm of the difference between the predefined category of the file and the predicted category of the file determined by the categorizer, the LDA model can extract more meaningful topics from the files, and thus the accuracy of the LDA model can be improved.

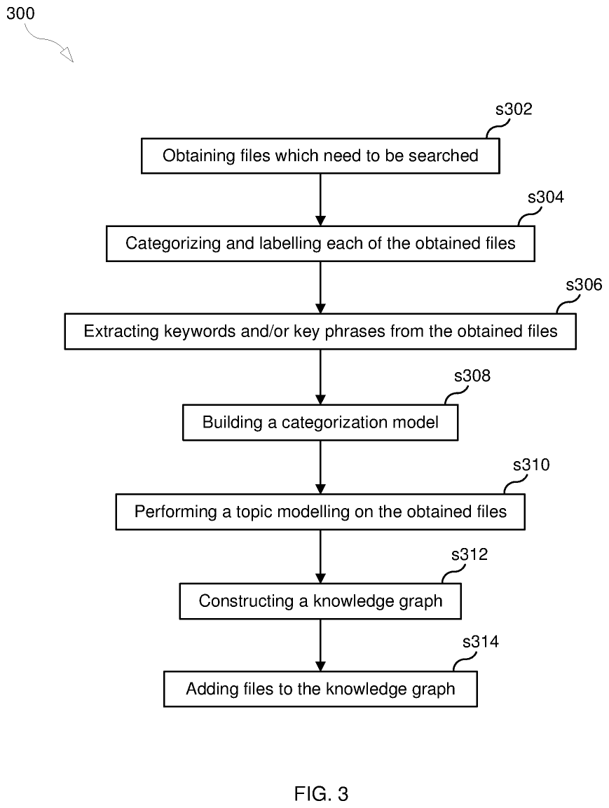

FIG. 3 shows a process 300 of constructing a knowledge base (e.g., a knowledge graph) according to some embodiments. The process 300 may begin with step s302.

In step s302, all files in a database which needs to be searched are obtained.

After obtaining the files, in step s304, each of the obtained files is categorized and labelled with one or more categories. For example, a document used by service engineers for managing wireless network equipment(s) may be labeled with categories—“installation” and “troubleshooting.” Because sentences included in a document are likely related to the category or the categories of the document, each sentence included in the document may also be categorized according to the category or the categories of the document.

After categorizing and labelling the files, in step s306, keywords and/or key phrases are extracted from the files using a character recognition engine (e.g., Tesseract optical character recognition (OCR) engine) and each of the files is divided based on sentences included in each file. Each of the extracted key phrases may be identified as a single word by connecting multiple words included in each key phrase with a hyphen, a dash, or an underscore (e.g., solving_no_connection_problem).

In step s308, a categorization model is built. The categorization model may be configured to receive one or more sentences as an input and to output one or more categories associated with the inputted sentence(s) as an output. The input of the categorization model is set to be in the form of a sentence (rather than a word or a paragraph) because a search query is generally in the form of a sentence. In some embodiments, CNN model may be used as the categorization model.

In step s310, a topic modelling is performed on files that are in the same category, and dominant keywords which form topic(s) in the files are identified. In some embodiments, LDA model may be used to perform the topic modelling.

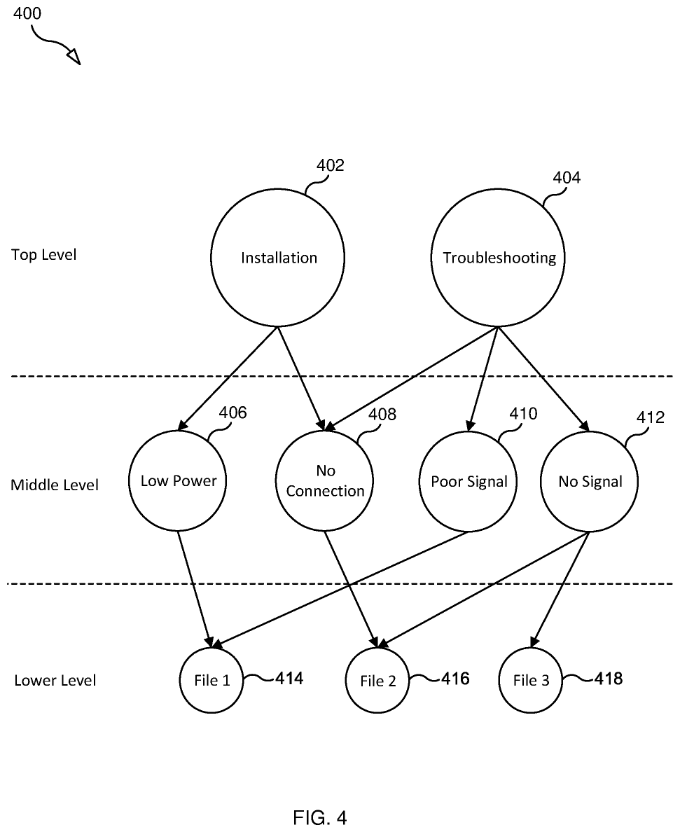

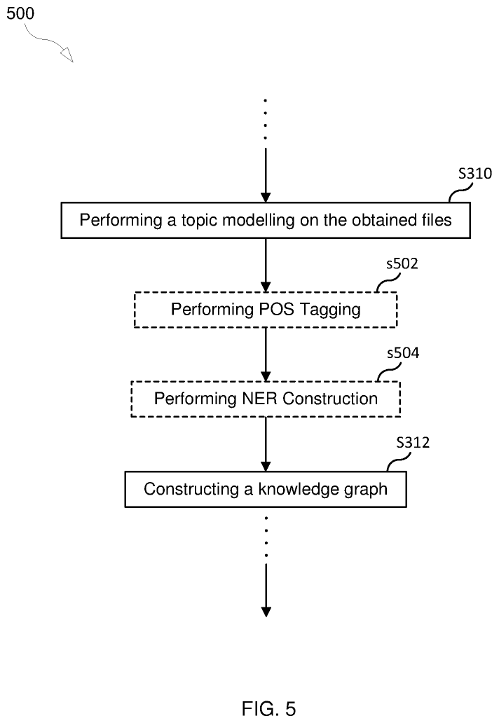

After identifying (i) categories of the files and (ii) topics associated with each of the categories of the files, a knowledge base is constructed in step s312. In the knowledge base, each of the categories, which is identified in step s304, may be assigned to a node in a top level (herein after “top node”) of the knowledge base and topics associated with each of the categories of the files may be assigned to nodes in a middle level (herein after “middle nodes”), which are branched from the top node. FIG. 4 illustrates an exemplary knowledge graph 400 constructed as a result of performing step s312.

As shown in FIG. 4, the knowledge graph 400 includes top nodes 402 and 404. Each of the top nodes 402 and 404 is associated with a category—“Installation” or “Troubleshooting.” The knowledge base 400 also includes middle nodes 406, 408, 410, and 412 which are branched from the top nodes 402 and 404. Each of the middle nodes 406, 408, 410, and 412 corresponds to a topic associated with at least one of the categories. For example, the middle node 408 corresponds to the topic (or keywords, key phrases)—“no connection”—and is associated with the categories—“Installation” and “Troubleshooting.”

After constructing the knowledge base in step s312, in step s314, nodes corresponding to names of the files are added to a lower level of the knowledge base. The nodes in the lower level (herein after “lower nodes”) are associated with one or more of the topics in the middle level of the knowledge base and are branched from the associated topics. For example, in the knowledge graph 400, the node 414 corresponds to the file name—“File 1”—and is branched from the nodes 406 and 410 corresponding to the topics associated with the “File 1”—“Low Power” and “Poor Signal.”

In some embodiments, after performing the topic modelling in step s310, two additional steps may be performed prior to constructing a knowledge base in step s312. Specifically, as shown in FIG. 5, after performing the topic modelling in step s310, Part-Of-Speech (POS) tagging may be performed in step s502. For example, after identifying topics in the topic modelling in step s310, a keyword associated with each of the identified topics may be labelled as a noun or a verb based on the location of the words within the topics.

After performing the POS tagging, in step s504, NER construction may be performed. In the NER construction step, one or more words included in the obtained files are labelled with what the words represent. For example, the word “London” may be labelled as a “capital” while the word “France” may be labelled as a “country.”

After performing the NER construction in step s504, a knowledge base may be constructed in step s312.

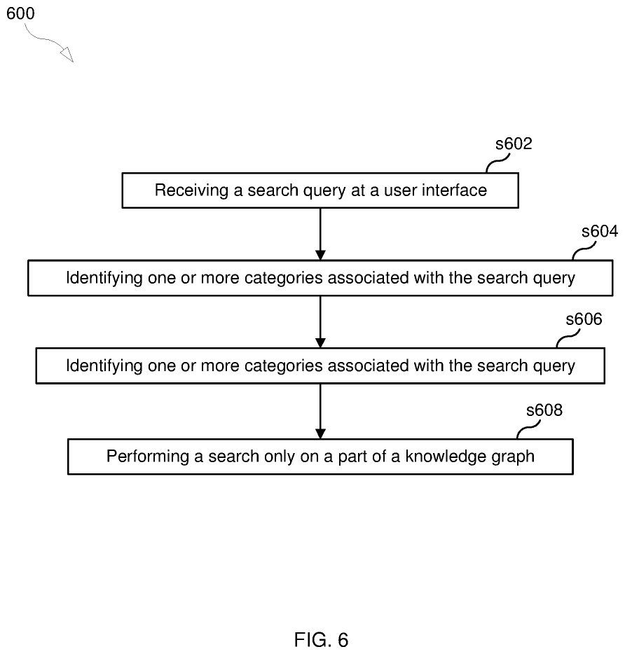

FIG. 6 shows a process 600 of performing a search on a knowledge base according to some embodiments. The process 600 may begin with step s602.

In step s602, a search query is received at a user interface. The user interface may be any device capable of receiving a user input. For example, the user interface may be a mouse, a keyboard, a touch panel, and a touch screen.

After receiving the search query, in step s604, one or more sentences corresponding to the search query is provided as input to a categorization model such that the categorization model identifies one or more categories associated with the search query. The categorization model used in this step may correspond to the categorization model built in step s408.

After identifying one or more categories associated with the search query, in step s606, a topic model identifies one or more topics associated with the search query based on one or more keywords of the search query. The topic model used in this step may correspond to the entity that performs the topic modelling in step s310.

Based on the identified categories and topics associated with the search query, in step s608, a search is performed only on a part of the knowledge base that involves the identified categories and the identified topics rather than on the whole knowledge base. By performing a search only on the part of a knowledge base that is most likely related to a user's search query, file(s) that is related to the search query may be retrieved faster.

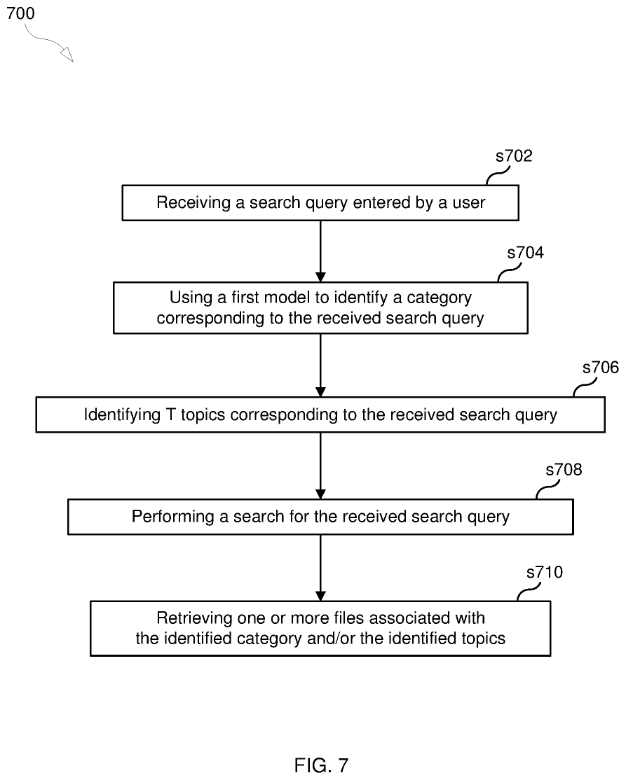

FIG. 7 is a flow chart illustrating a process 700 for retrieving information using a knowledge base. The process 700 may begin with step s702.

Step s702 comprises receiving a search query entered by a user.

Step s704 comprises based on the received search query, using a first model to identify a category corresponding to the received search query. One or more files may be assigned to the identified category and the first model may be a categorization model that functions to map an input to one of M different categories, where M is greater than 1.

Step s706 comprises based on (i) the received search query, (ii) a loss function of the first model, and (iii) an objective function of a second model, identifying T topics corresponding to the received search query, where T is greater than or equal to 1.

Step s708 comprises using the identified category and the identified topics, performing a search for the received search query only on a part of the knowledge base that is associated with the identified category and/or the identified topics.

Step s710 comprises based on the performed search, retrieving one or more files associated with the identified category and/or the identified topics.

In some embodiments, the process 700 may further comprise constructing the knowledge base. Constructing the knowledge base may comprise obtaining a set of N files, each of which is assigned to one of the M different categories, where N is greater than 1. Constructing the knowledge base may also comprise based on (i) content of the N files, (ii) the loss function of the first model, and (iii) the objective function of the second model, identifying a set of topics, where each topic is a group of one or more keywords. Constructing the knowledge base may further comprise generating the knowledge base using the identified topics and for each one of the N files, based on a particular category to which the file is assigned and keywords included in the file, adding the file to the knowledge base.

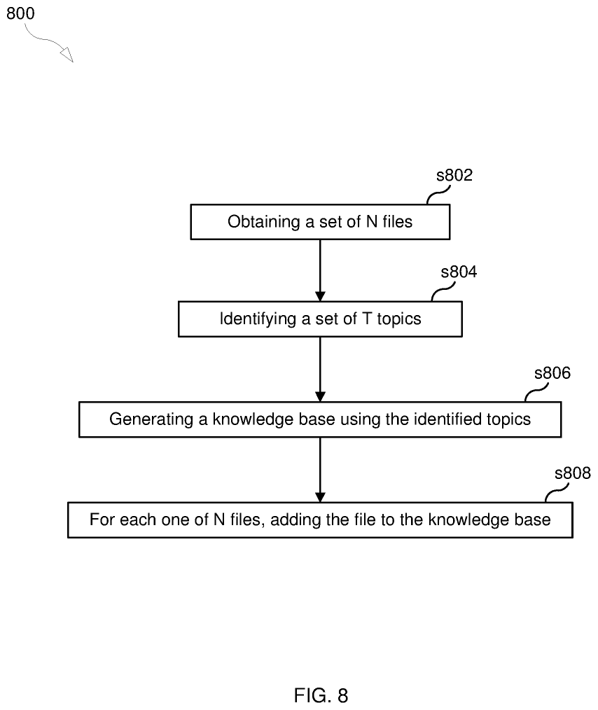

FIG. 8 is a flow chart illustrating a process 800 for constructing a knowledge base. The process 800 may begin within step s802.

Step s802 comprises obtaining a set of N files each of which is assigned to one of M different categories, where N and M are greater than 1.

Step s804 comprises based on (i) content of the N files, (ii) a loss function of a first model, and (iii) an objective function of a second model, identifying a set of T topics, where T is greater than 1 and each topic is a group of one or more keywords.

Step s806 comprises generating the knowledge base using the identified topics.

Step s808 comprises for each one of the N files, based on a particular category to which the file is assigned and keywords included in the file, adding the file to the knowledge base.

The first model may be a categorization model that functions to map an input sentence to one of the M categories.

In some embodiments, the categorization model is a machine learning (ML) model. The process 800 may further train the ML model using the categorized files as training data.

In some embodiments, identifying the set of T topics comprises identifying said group of one or more keywords of each topic using a sum of the loss function of the first model and the objective function of the second model.

In some embodiments, the loss function of the first model depends at least on a probability distribution of each topic of the set of T topics and a stochastic parameter influencing a distribution of words in each topic of the set of T topics.

In some embodiments, the objective function of the second model depends at least on a predetermined category of a file and a predicted output of the first model.

In some embodiments, the second model is Latent Dirichlet Allocation (LDA) model.

In some embodiments, the process 800 comprises performing a POS tagging on keywords associated with the identified set of T topics.

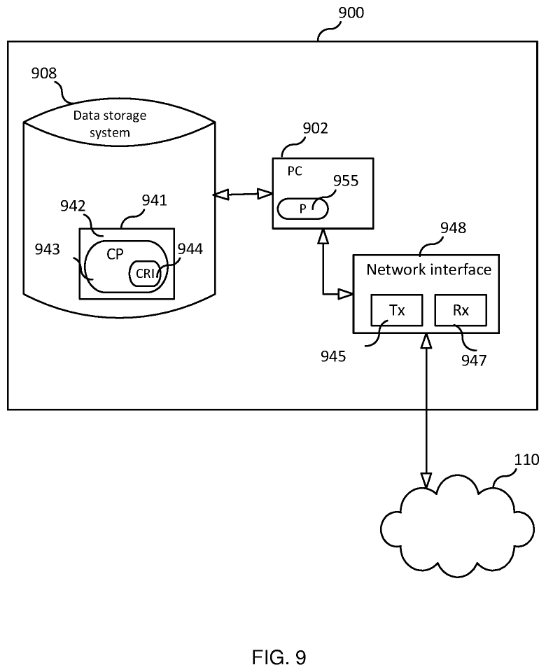

FIG. 9 is a block diagram of an apparatus 900, according to some embodiments, for performing the methods disclosed herein. As shown in FIG. 9, apparatus 900 may comprise: processing circuitry (PC) 902, which may include one or more processors (P) 955 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 900 may be a distributed computing apparatus); at least one network interface 948 comprising a transmitter (Tx) 945 and a receiver (Rx) 947 for enabling apparatus 900 to transmit data to and receive data from other nodes connected to a network 110 (e.g., an Internet Protocol (IP) network) to which network interface 948 is connected (directly or indirectly) (e.g., network interface 948 may be wirelessly connected to the network 110, in which case network interface 948 is connected to an antenna arrangement); and a storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes apparatus 900 to perform steps described herein (e.g., steps described herein with reference to the flow charts). In other embodiments, apparatus 900 may be configured to perform steps described herein without the need for code. That is, for example, PC 902 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method of retrieving information using a knowledge base, the method comprising:
receiving a search query entered by a user;
based on the received search query, using a first model to identify a category corresponding to the received search query, wherein one or more files are assigned to the identified category and further wherein the first model is a categorization model that functions to map an input to one of M different categories, where M is greater than 1;
based on (i) the received search query, (ii) a loss function of the first model, and (iii) an objective function of a second model, identifying T topics corresponding to the received search query, where T is greater than or equal to 1;
using the identified category and the identified topics, performing a search for the received search query only on a part of the knowledge base that is associated with the identified category and/or the identified topics; and
based on the performed search, retrieving one or more files associated with the identified category and/or the identified topics.

2. The method of claim 1, further comprising constructing the knowledge base, wherein constructing the knowledge base comprises:
obtaining a set of N files, wherein each file included in the set of files is assigned to one of the M different categories, where N is greater than 1;
based on (i) content of the N files, (ii) the loss function of the first model, and (iii) the objective function of the second model, identifying a set of topics, where each topic is a group of one or more keywords;
generating the knowledge base using the identified topics; and
for each one of the N files, based on a particular category to which the file is assigned and keywords included in the file, adding the file to the knowledge base.

3. A method for constructing a knowledge base, the method comprising:
obtaining a set of N files, wherein each file included in the set of files is assigned to one of M different categories, where N and M are greater than 1;
based on (i) content of the N files, (ii) a loss function of a first model, and (iii) an objective function of a second model, identifying a set of T topics, where T is greater than 1 and each topic is a group of one or more keywords;
generating the knowledge base using the identified topics; and
for each one of the N files, based on a particular category to which the file is assigned and keywords included in the file, adding the file to the knowledge base, wherein
the first model is a categorization model that functions to map an input sentence to one of the M categories.

4. The method of claim 2, wherein
the categorization model is a machine learning (ML) model, and
the method further comprises training the ML model using the categorized files as training data.

5. The method of claim 2, wherein identifying the set of T topics comprises identifying said group of one or more keywords of each topic using a sum of the loss function of the first model and the objective function of the second model.

6. The method of claim 2, wherein
the loss function of the first model depends at least on a probability distribution of each topic of the set of T topics and a stochastic parameter influencing a distribution of words in each topic of the set of T topics.

7. The method of claim 2, wherein
the objective function of the second model depends at least on a predetermined category of a file and a predicted output of the first model.

8. The method of claim 2, wherein the second model is Latent Dirichlet Allocation (LDA) model.

9. The method of claim 2, further comprising:
performing a Part-Of-Speech (POS) tagging on keywords associated with the identified set of T topics.

10. An apparatus for retrieving information using a knowledge base, the apparatus being adapted to:
receive a search query entered by a user;
based on the received search query, use a first model to identify a category corresponding to the received search query, wherein one or more files are assigned to the identified category and further wherein the first model is a categorization model that functions to map an input to one of M different categories, where M is greater than 1;
based on (i) the received search query, (ii) a loss function of the first model, and (iii) an objective function of a second model, identify T topics corresponding to the received search query, where T is greater than or equal to 1;
using the identified category and the identified topics, perform a search for the received search query only on a part of the knowledge base that is associated with the identified category and/or the identified topics; and
based on the performed search, retrieve one or more files associated with the identified category and/or the identified topics.

11. The apparatus of claim 10, the apparatus further being adapted to construct the knowledge base, wherein constructing the knowledge base comprises:
obtaining a set of N files, wherein each file included in the set of files is assigned to one of the M different categories, where N is greater than 1;
based on (i) content of the N files, (ii) the loss function of the first model, and (iii) the objective function of the second model, identifying a set of topics, where each topic is a group of one or more keywords;
generating the knowledge base using the identified topics; and
for each one of the N files, based on a particular category to which the file is assigned and keywords included in the file, adding the file to the knowledge base.

12. An apparatus for constructing a knowledge base, the apparatus being adapted to:
obtain a set of N files, wherein each file included in the set of files is assigned to one of M different categories, where N and M are greater than 1;
based on (i) content of the N files, (ii) a loss function of a first model, and (iii) an objective function of a second model, identify a set of T topics, where T is greater than 1 and each topic is a group of one or more keywords;
generate the knowledge base using the identified topics; and
for each one of the N files, based on a particular category to which the file is assigned and keywords included in the file, add the file to the knowledge base, wherein
the first model is a categorization model that functions to map an input sentence to one of the M categories.

13. The apparatus of claim 12, wherein
the categorization model is a machine learning (ML) model, and
the method further comprises training the ML model using the categorized files as training data.

14. The apparatus of claim 12, wherein identifying the set of T topics comprises identifying said group of one or more keywords of each topic using a sum of the loss function of the first model and the objective function of the second model.

15. The apparatus of claim 12, wherein
the loss function of the first model depends at least on a probability distribution of each topic of the set of T topics and a stochastic parameter influencing a distribution of words in each topic of the set of T topics.

16. The apparatus of claim 12, wherein
the objective function of the second model depends at least on a predetermined category of a file and a predicted output of the first model.

17. The apparatus of claim 12, wherein the second model is Latent Dirichlet Allocation (LDA) model.

18. The apparatus of claim 12, further comprising:
performing a Part-Of-Speech (POS) tagging on keywords associated with the identified set of T topics.

19. A computer program comprising instructions which when executed by processing circuitry causes the processing circuitry to perform the method of claim 1.

20. A carrier containing the computer program of claim 19, wherein the carrier is one of an electronic signal, an optical signal, a radio signal, and a computer readable storage medium.

21-24. (canceled)
